(19) United States
(12) Patent Application Publication
(10) Pub. No.: US 2008/0151154 A1
(43) Pub. Date: Jun. 26, 2008

(54) Color filter having isosceles trapezoidal color filter subunits and liquid crystal panel with same

(75) Inventor: Sung-Yen Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/005,017

(22) Filed: Dec. 21, 2007

(30) Foreign Application Priority Data
Dec. 22, 2006 (CN) 200610157869.2

(51) Int. Cl. G02F 1/1335

(52) U.S. Cl. 349/106

(57) ABSTRACT

An exemplary color filter (27) includes color filter subunits (271, 272, 273, 274) arranged in a matrix. Each of the color filter subunits is in the shape of an isosceles trapezoid, and is inverted relative to its neighboring filter units. Because each of the filter subunits is in the shape of an isosceles trapezoid, and is inverted relative to its neighboring filter subunits, interfaces between adjacent filter subunits are oblique and relatively long, so that the color mixing effect of the color filter is improved.

### FIELD OF THE INVENTION

The present invention relates color filters used in liquid crystal panels, and particularly to color filter having a plurality of isosceles trapezoidal color filter subunits and a liquid crystal panel including the color filter.

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions. An LCD generally includes a liquid crystal panel, a driving circuit for driving the liquid crystal panel, and a backlight module for illuminating the liquid crystal panel.

Referring to FIG. 3, a typical liquid crystal panel 10 includes a first substrate 11, a second substrate 13 parallel to the first substrate 11, and a liquid crystal layer 15 interposed between the two substrates 11, 13. The first substrate 11 includes a color filter 17 on an inner surface thereof adjacent to the liquid crystal layer 15.

Referring also to FIG. 4, the color filter 17 includes a plurality of color filter units 170 arranged in a regular array. Each of color filter units 170 includes a red (R) filter subunit 171, a green (G) filter subunit 172, a blue (B) filter subunit 173, and a white (W) filter subunit 174, arranged in that order from left to right as shown. The filter subunits 171, 172, 173, 174 are substantially rectangular. In each row of the array, the filter subunits 171, 172, 173, 174 are arranged in a pattern of repeating “RGBW” filter subunits. In each column of the array, the filter subunits 171, 172, 173 or 174 cooperatively form columns having the same color; namely “R” colored columns, “G” colored columns, “B” colored columns, and “W” colored columns.

The second substrate 13 includes a plurality of pixel electrodes (not shown). Each pixel electrode corresponds to a respective filter subunit 171, 172, 173, 174 in location, shape, and size. The pixel electrodes are used to generate an electric field, which twists liquid crystal molecules of the liquid crystal layer 15. Thereby, an amount of light penetrating through the liquid crystal layer 15 is controlled, and a desired color display is achieved.

The white filter subunits 174 of the color filter 17 have high light transmittance, and therefore substantially increase a brightness of the liquid crystal panel 10. However, because the filter subunits 171, 172, 173, 174 are substantially rectangular and are arranged in a matrix, in each row, interfaces between adjacent filter subunits 171, 172, 173, 174 are not enough large. This means the color mixing effect of the color filter 17 may not be sufficient. Accordingly, the color display performance of the liquid crystal panel 10 be unsatisfactory. Furthermore, because all the internal angles of the filter subunits 171, 172, 173, 174 are right angles, when the liquid crystal panel 10 displays a curved line, the displayed curved line is liable to include right-angled sawteeth. That is, the display performance of the liquid crystal panel 10 is impaired.

What is needed, therefore, is a new color filter that can overcome the above-described deficiencies. What is also needed is a liquid crystal panel employing such color filter.

### SUMMARY

In one preferred embodiment, a color filter includes a plurality of color filter subunits arranged in a matrix. Each of the color filter subunits is in the shape of an isosceles trapezoid, and is inverted relative to its neighboring filter subunits.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a side cross-sectional view of a liquid crystal panel according to an exemplary embodiment of the present invention, the liquid crystal panel including a color filter.

FIG. 2 is an enlarged, top plan view of part of the color filter of the liquid crystal panel of FIG. 1.

FIG. 3 is a side cross-sectional view of a conventional liquid crystal panel.

FIG. 4 is an enlarged, top plan view of part of the color filter of the liquid crystal panel of FIG. 3.

### DETAILED DESCRIPTION OF PREFERRED EMBODIMENTS

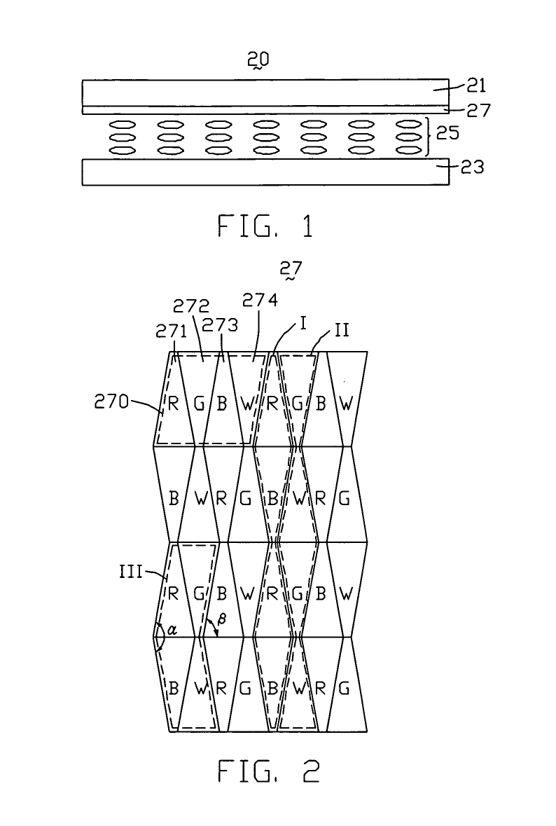

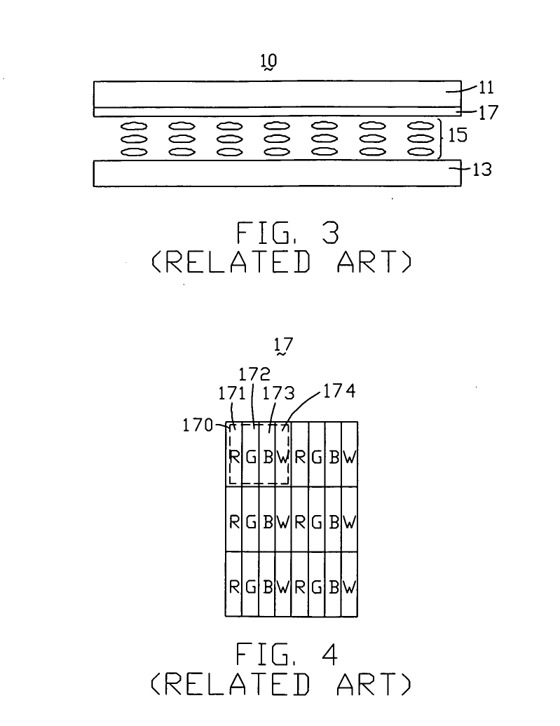

Referring to FIG. 1, a liquid crystal panel 20 according to an exemplary embodiment of the present invention is shown. The liquid crystal panel 20 includes a first substrate 21, a second substrate 23 parallel to the first substrate 21, and a liquid crystal layer 25 interposed between the two substrates 21, 23. The first substrate 21 includes a color filter 27 on an inner surface thereof adjacent to the liquid crystal layer 25.

Referring also to FIG. 2, the color filter 27 includes a plurality of color filter units 270. Each of the color filter units 270 includes a red (R) filter subunit 271, a green (G) filter subunit 272, a blue (B) filter subunit 273, and a white (W) filter subunit 274. The filter subunits 271, 272, 273, 274 are arranged in a matrix. In each row of the matrix, the filter subunits 271, 272, 273, 274 are arranged in a pattern of repeating “RGBW” filter subunits. In odd-numbered columns of the matrix (such as column I as shown in FIG. 2), the red filter subunits 271 and the blue filter subunits 273 are alternately arranged. In even-numbered columns of the matrix (such as column II as shown in FIG. 2), the green filter subunits 272 and the white filter subunits 274 are alternately arranged.

Each of the filter subunits 271, 272, 273, 274 is in the shape of an isosceles trapezoid. Each filter subunit 271, 272, 273, 274 is inverted relative to its two neighboring filter subunits 271, 272, 273, 274, both along the same row and along the same column. In each column, two adjacent sides of each two neighboring filter subunits 271, 272, 273, 274 are connected. The two adjacent sides define an internal obtuse angle therebetween. For example, in region III of FIG. 2, a side of the red filter subunit 271 and a side of the neighboring blue filter subunit 273 are connected, and define an internal obtuse angle α therebetween. In each row, a nonparallel side of the isosceles trapezoid of each filter subunit 271, 272, 273, 274 and a parallel side of the isosceles trapezoid of the corresponding neighboring filter subunit 271, 272, 273, 274 are connected. The adjacent nonparallel side and parallel side define an acute angle therebetween. For example, in region III of FIG. 2, a nonparallel side of the green filter subunit 272 and a nonparallel side of the blue filter subunit 273 define an acute angle β therebetween.

The second substrate 23 includes a plurality of pixel electrodes (not shown). Each pixel electrode corresponds to a respective filter subunit 271, 272, 273, 274 in location, shape, and size. The pixel electrodes and the filter subunits 271, 272, 273, 274 cooperatively define a plurality of pixel regions. The pixel electrodes are used to generate an electric field, which twists liquid crystal molecules of the liquid crystal layer 25. Thereby, an amount of light penetrating through the liquid crystal layer 25 in each of the pixel regions is controlled, and a desired color display is achieved.

In particular, after the light penetrates through the liquid crystal layer 25, the light is incident on the color filter 27. When the incident light passes through the red, green and blue filter subunits 271, 272, 273 of the color filter 27, red light, green light and blue light are respectively generated, and the red light, green light and blue light can be mixed into any desired color according to the amount of the incident light in each of the pixel regions. The white filter subunits 274 have higher light transmittance, and therefore can increase a brightness of the liquid crystal panel 20.

Unlike with a conventional color filter, each of the filter subunits 271, 272, 273, 274 is in the shape of an isosceles trapezoid, and is inverted relative to its neighboring filter subunits 271, 272, 273, 274, in each row of the color filter 27 and in each column of the color filter 27. Therefore interfaces between adjacent filter subunits 271, 272, 273, 274 are oblique and relatively long, so that the color mixing effect of the color filter 27 is improved. Accordingly, the color display performance of the liquid crystal panel 20 is improved. None of the internal or external angles of adjacent filter subunits 271, 272, 273, 274 are right angles. Therefore any right-angled sawtooth phenomenon that may otherwise occur when a curved line is displayed can be effectively mitigated or even eliminated. Accordingly, the clarity of the display performance of the liquid crystal panel 20 is improved.

Further or alternative embodiments may include the following. In a first example, in odd-numbered columns, the green filter subunits 272 and the white filter subunits 274 are alternately arranged, and in even-numbered columns, the red filter subunits 271 and the blue filter subunits 273 are alternately arranged. In a second example, in each row, the filter subunits 271, 272, 273, 274 are arranged in a pattern of repeating “GBRW” filter subunits. In a third example, in each column, the filter subunits 271, 272, 273, 274 are arranged in a pattern of repeating “BGRW” filter subunits. Other examples similar to the above examples can also be configured.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A color filter comprising a plurality of color filter subunits arranged in a matrix, each of the color filter subunits being in the shape of an isosceles trapezoid, and being inverted relative to its neighboring filter subunits.

2. The color filter as claimed in claim 1, wherein the color filter subunits comprise red (R) filter subunits, green (G) filter subunits, blue (B) filter subunits, and white (W) filter subunits.

3. The color filter as claimed in claim 2, wherein in each row of the matrix, each of the color filter subunits has a different color from its neighboring filter submits.

4. The color filter as claimed in claim 3, wherein in each row, the color filter subunits are arranged in a pattern of repeating “RGBW” color filter subunits.

5. The color filter as claimed in claim 3, wherein in each row, the color filter subunits are arranged in a pattern of repeating “GBRW” color filter subunits.

6. The color filter as claimed in claim 2, wherein in each column of the matrix, each of the color filter subunits has a different color from its neighboring filter subunits.

7. The color filter as claimed in claim 6, wherein in odd-numbered columns of the matrix, the red filter subunits and the blue filter subunits are alternately arranged, and in even-numbered columns of the matrix, the green filter subunits and the white filter subunits are alternately arranged.

8. The color filter as claimed in claim 6, wherein in odd-numbered columns of the matrix, the green filter subunits and the white filter subunits are alternately arranged, and in even-numbered columns of the matrix, the red filter subunits and the blue filter subunits are alternately arranged.

9. The color filter as claimed in claim 6, wherein in each column, the filter subunits are arranged in a pattern of repeating “BGRW” color filter subunits.

10. A liquid crystal panel comprising:
a first substrate comprising a color filter, the color filter comprising a plurality of color filter subunits arranged in a matrix, each of the color filter subunits being in the shape of an isosceles trapezoid, and being inverted relative to its neighboring filter subunits;
a second substrate parallel to the first substrate; and
a liquid crystal layer interposed between the first and second substrates.

11. The liquid crystal panel as claimed in claim 10, wherein the color filter subunits comprise red (R) filter subunits, green (G) filter subunits, blue (B) filter subunits, and white (W) filter subunits.

12. The liquid crystal panel as claimed in claim 11, wherein in each row of the matrix, each of the color filter subunits has a different color from its neighboring filter submits.

13. The liquid crystal panel as claimed in claim 12, wherein in each row, the color filter subunits are arranged in a pattern of repeating “RGBW” color filter subunits.

14. The liquid crystal panel as claimed in claim 12, wherein in each row, the color filter subunits are arranged in a pattern of repeating “GBRW” color filter subunits.

15. The liquid crystal panel as claimed in claim 11, wherein in each column of the matrix, each of the color filter subunits has a different color from its neighboring filter subunits.

16. The liquid crystal panel as claimed in claim 15, wherein in odd-numbered columns of the matrix, the red filter subunits and the blue filter subunits are alternately arranged, and in even-numbered columns of the matrix, the green filter subunits and the white filter subunits are alternately arranged.

17. The liquid crystal panel as claimed in claim 15, wherein in odd-numbered columns of the matrix, the green filter subunits and the white filter subunits are alternately arranged, and in even-numbered columns of the matrix, the red filter subunits and the blue filter subunits are alternately arranged.

18. The liquid crystal panel as claimed in claim 15, wherein in each column, the filter subunits are arranged in a pattern of repeating “BGRW” color filter subunits.

19. A color filter comprising a plurality of color filter units, each of the color filter units comprising a plurality of color filter subunits, the color filter subunits arranged in a matrix, wherein two adjacent sides of each two adjacent color filter subunits along any column of the matrix define an obtuse angle therebetween.

20. The color filter as claimed in claim 19, wherein each of the color filter subunits is in the shape of an isosceles trapezoid, and the color filter subunits in each color filter unit comprise a red filter subunit, a green filter subunit, a blue filter subunit, and a white filter subunit.
